(19) United States
(12) Patent Application Publication
(10) Pub. No.: US 2010/0328821 A1
(43) Pub. Date: Dec. 30, 2010

(54) HARD DISK DRIVE

(75) Inventors: Woo Chul KIM, Suwon-si (KR); Yong Han Song, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/813,619

(22) Filed: Jun. 11, 2010

(30) Foreign Application Priority Data
Jun. 25, 2009 (KR) 2009-0056957

(51) Int. Cl. G11B 5/54; G11B 21/18

(52) U.S. Cl. 360/256.2; 360/270; G9B/5.181; G9B/21.024

(57) ABSTRACT

A hard disk drive includes an actuator arm pivoting over a disk around a pivot shaft as a center of rotation to allow a read/write head to access data on the disk, a bobbin provided at the opposite side to the read/write head with respect to a pivot shaft holder that rotatably supports the pivot shaft, and a voice coil coupled to the bobbin. The bobbin includes a bobbin body coupled an end portion of the voice coil adjacent to the pivot shaft holder, and a plurality of bobbin legs extending from an end portion of the bobbin body toward areas of the other end portion of the voice coil that are separated from each other, and coupled to the areas of the other end portion of the voice coil that are separated from each other.

### CROSS-REFERENCE TO RELATED APPLICATIONS

This application claims priority under 35 U.S.C. §119 from Korean Patent Application No. 10-2009-0056957, filed on Jun. 25, 2009, in the Korean Intellectual Property Office, the disclosure of which is incorporated herein in its entirety by reference.

### BACKGROUND

1. Field of the General Inventive Concept

The general inventive concept relates to a hard disk drive, and more particularly, to a hard disk drive which may reduce track mis-registration (TMR) by increasing a servo bandwidth.

2. Description of the Related Art

Hard disk drives (HDDs) are data storage devices capable of recording data on a disk or reading data stored on the disk by converting a digital electronic pulse including data information into a perpetual magnetic field. The HDD is widely used as an auxiliary memory device for computer systems because of its fast access time to a large amount of data.

The HDD includes a disk to record data, a spindle motor to rotate the disk, a head stack assembly (HSA) having an actuator arm on which a read/write head to write data to the disk or read the data from the disk is mounted, a voice coil motor (VCM) to pivot the actuator arm to move the read/write head to a desired position on the disk, and a base on which the above parts are installed.

The HSA is a carriage to record data on the disk or read the data recorded on the disk and includes the above-described read/write head, an actuator arm pivoting around a pivot shaft across the disk to allow the read/write head to access data on the disk, a pivot shaft holder rotatably supporting the pivot shaft and supporting the actuator arm that is coupled thereto, and a bobbin provided at the opposite side of the actuator arm with respect to the pivot shaft holder. The bobbin is generally manufactured of plastic.

The HSA of the HDD has a variety of resonance modes, among which an in-plane resonance mode mostly affects a tracking operation of the actuator arm. The in-plane resonance mode is generally referred to as a butterfly mode.

FIG. 1 schematically illustrates the butterfly mode of an HSA 9 of a general HDD. Referring to FIG. 1, in the HSA 9 of the HDD, a portion 93a of an actuator arm 93 provided at one side of a pivot shaft holder 92 and another portion 93b of the actuator arm 93, to which a bobbin 94 is coupled, provided at the other side of the pivot shaft holder 92 are in the shape of being twisted with each other with respect to a pivot shaft 91 as a shaft center, during driving, by the butterfly mode.

The butterfly mode generates track mis-registration (TMR) so that a read/write head 95 may not precisely follow a track. As a result, the performance of the HDD is deteriorated. To reduce the TMR due to the butterfly mode of the HSA 9, a method to increase a servo bandwidth may be considered. In order to increase the servo bandwidth, a butterfly mode frequency has to be increased.

To increase the butterfly mode frequency, the use of a bobbin manufactured of a metal material, for example, aluminum, instead of plastic material may be considered. However, when the bobbin manufactured of a metal material, such as aluminum, is used, it is a problem that mass and moment of inertia of the bobbin are increased. Thus, when a metal bobbin is to be used, the butterfly mode frequency should be increased without an increase in the mass or the mass and the moment of inertia of the bobbin, thereby reducing the TMR.

### SUMMARY

The general inventive concept provides a hard disk drive which increases a butterfly mode (BFM) frequency of a head stack assembly to increase a servo bandwidth so that track mis-registration (TMR) may be reduced.

Additional features and utilities of the present general inventive concept will be set forth in part in the description which follows and, in part, will be obvious from the description, or may be learned by practice of the general inventive concept.

Embodiments of the present general inventive concept may be achieved by providing a hard disk drive including an actuator arm to pivot over a disk around a pivot shaft as a center of rotation to allow a read/write head disposed on one side of the pivot shaft to access data on the disk, a bobbin provided at the opposite side to the read/write head with respect to a pivot shaft holder that rotatably supports the pivot shaft, and a voice coil coupled to the bobbin, in which the bobbin includes a bobbin body coupled to a first end portion of the voice coil adjacent to the pivot shaft holder, and a plurality of bobbin legs extending from an end portion of the bobbin body toward areas of a second end portion of the voice coil on an opposite side of the first end portion of the voice coil, and coupled to the areas of the second end portion of the voice coil.

The plurality of bobbin legs may be a pair of bobbin legs, and the bobbin may substantially have a plane [symbol] shape.

The voice coil may substantially have a trapezoidal shape, and the pair of bobbin legs may be extended from the end portion of the bobbin body toward both corners of the second end portion of the voice coil, forming an obtuse angle, and coupled to both corners of the second end portion of the voice coil.

The bobbin body may have a height to correspond to ⅘ to ⅚ of the overall height of the bobbin.

The bobbin body may include a pair of first body units, each having an upper surface provided on the substantially same plane with an upper surface of each of the pair of bobbin legs, and a second body unit having an upper surface at a position lower than an upper surface of each of the pair of first body units.

The pair of first body units may respectively extend from a base portion of each of the pair of bobbin legs, to substantially form an “X” shape with the pair of bobbin legs, and the second body unit may substantially have a trapezoidal shape.

The thicknesses of the first body units and the second body unit may be different from each other, and a width of a portion of the second body unit adjacent to the pivot shaft holder may be smaller than a width of an opposite portion of the second body unit.

A width of a portion of the bobbin body adjacent to the pivot shaft holder may be larger than a width of an opposite portion of the bobbin body, and the plurality of bobbin legs may be a pair of bobbin legs extending from both corner portions of the end portion of the bobbin body and respectively coupled to the areas of the second end portion of the voice coil that are separated from each other.

A width of a portion of the bobbin body adjacent to the pivot shaft holder may be smaller than a width of an opposite portion of the bobbin body, and the plurality of bobbin legs may be a pair of bobbin legs extending from a center portion of the end portion of the bobbin body and respectively coupled to the areas of the second end portion of the voice coil that are separated from each other.

The bobbin may be formed of a metal material. The bobbin may be formed of aluminum or an aluminum alloy.

Embodiments of the present general inventive concept may also be achieved by providing a hard disk drive including at least one hard disk, a head stack assembly to vibrate at a resonance frequency during an operation thereof, the head stack assembly having a pivot shaft and further including an actuator arm having a read/write head positioned on one side of the pivot shaft, and a voice coil wound around a bobbin on another side of the pivot shaft, the bobbin having a shape configured to increase the resonance frequency of the head stack assembly

The bobbin may further include a body portion adjacent to a first end of the voice coil, and a plurality of leg portions extending from the body portion to a second end of the voice coil.

The body portion may further include a plurality of first body units connected to the plurality of leg portions on a first level of the bobbin, and a second body unit disposed below and in contact with the plurality of first body units, the second body unit having a trapezoidal shape.

The plurality of leg portions may have substantially the same width.

The body portion may have a first width and the plurality of leg portions are separated from each other be a second width larger than the first width.

The bobbin may be formed of a metal material.

Embodiments of the present general inventive concept may also be achieved by providing an actuator arm including a read/write head disposed at one end thereof, a voice coil disposed at an opposite end thereof and a pivot shaft holder disposed between the read/write head and the voice coil, and a bobbin disposed within the voice coil, the bobbin including a body portion and two leg portions extending from the body portion and at a predetermined angle away from each other.

The bobbin may be formed of a metal comprising at least one of aluminum and an aluminum alloy.

The two leg portions may extend from the body portion to form an acute angle with each other.

The body portion and the two leg portions substantially form a “Y” shape.

### BRIEF DESCRIPTION OF THE DRAWINGS

Exemplary embodiments of the present general inventive concept will be more clearly understood from the following detailed description taken in conjunction with the accompanying drawings in which:

The above and/or other features and utilities of the present general inventive concept will become apparent and more readily appreciated from the following description of the exemplary embodiments, taken in conjunction with the accompanying drawings, in which:

FIG. 1 schematically illustrates the butterfly mode of a HSA of a general HDD;

FIG. 2 is an exploded perspective view illustrating major parts of an HDD according to an exemplary embodiment of the present general inventive concept;

FIG. 3 is a perspective view illustrating that the major parts of the HDD of FIG. 1 are assembled;

FIG. 4 is a perspective view illustrating a bobbin of the HDD of FIG. 1 in detail;

FIG. 5 is a perspective view illustrating the shape of the bobbin of FIG. 4 that is changed for convenience of manufacturing;

FIG. 6 schematically illustrates a modeling process to optimize the phase of the bobbin of FIG. 4;

FIGS. 7-10 are perspective views schematically illustrating the phase optimization design process of the bobbin of FIG. 6;

FIG. 11 is a perspective view illustrating a bobbin of an HDD according to another exemplary embodiment of the present general inventive concept;

FIG. 12 is a perspective view illustrating the shape of the bobbin of FIG. 11 that is changed for convenience of manufacturing; and

FIG. 13 is a perspective view illustrating a bobbin of an HDD according to another exemplary embodiment of the present general inventive concept.

FIGS. 14 and 15 are perspective views illustrating alternate shapes of a bobbin according to exemplary embodiments of the present general inventive concept

### DETAILED DESCRIPTION OF THE EMBODIMENTS

The attached drawings illustrating embodiments of the general inventive concept are referred to in order to gain a sufficient understanding of the general inventive concept and the merits thereof. Hereinafter, the general inventive concept will be described in detail by explaining embodiments of the general inventive concept with reference to the attached drawings. Like reference numerals in the drawings denote like elements.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

As described herein, terms such as “height” and “width” are relative dimensions to the positioning of components such as a bobbin body or bobbin legs at different points in an angular rotation of a bobbin. For example, in some rotational positions, the “height” of a bobbin body as described herein may be synonymous with a “width” in a different rotational position and a “length” in yet another position. In other positions, the dimension discussed may have a “diagonal” or angled dimension that may not fit into traditional definitional categories. Thus, the provision of certain terms such as “height” and “width” are not meant to limit the orientation of different components in any way, and are merely provided to allow better understanding of the relative dimensions of the elements and features of the present general inventive concept.

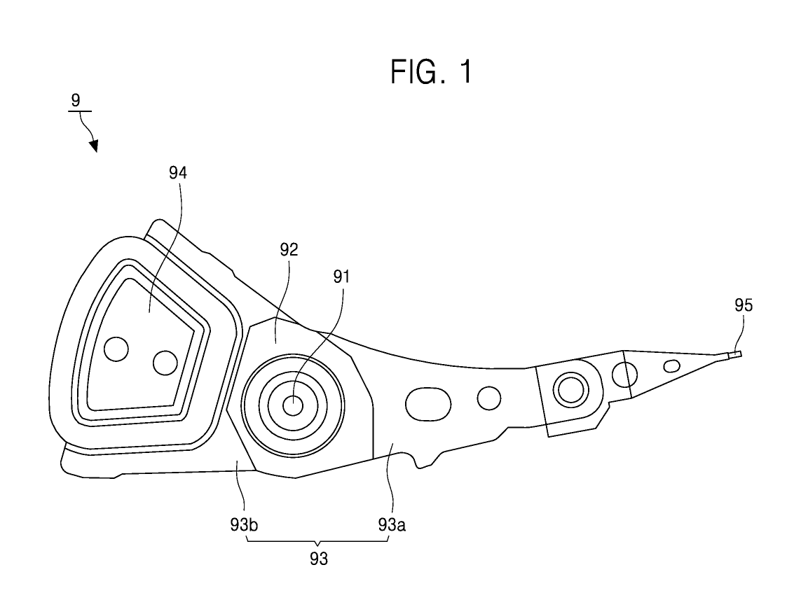

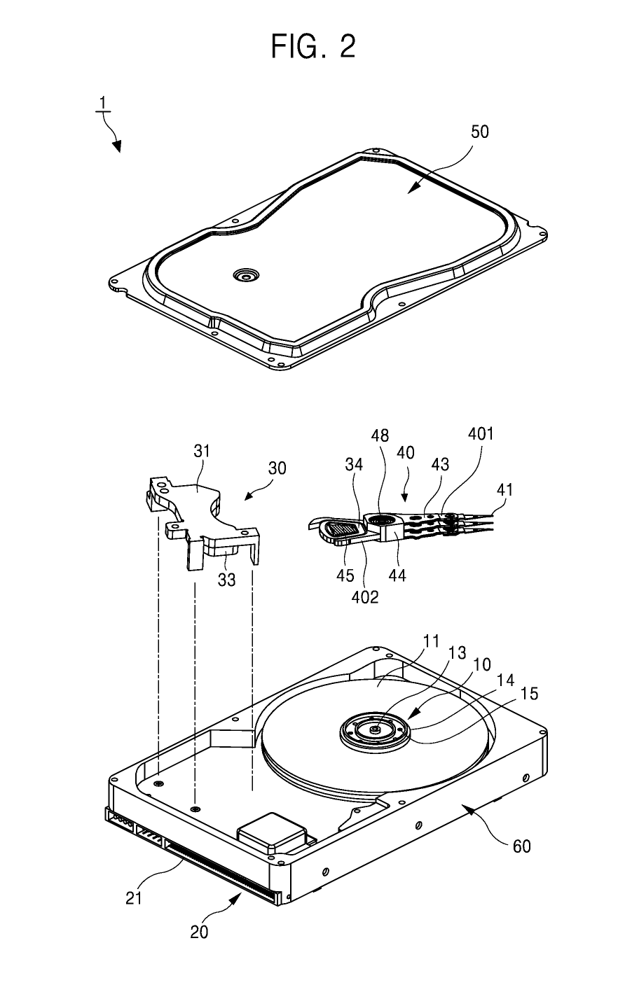

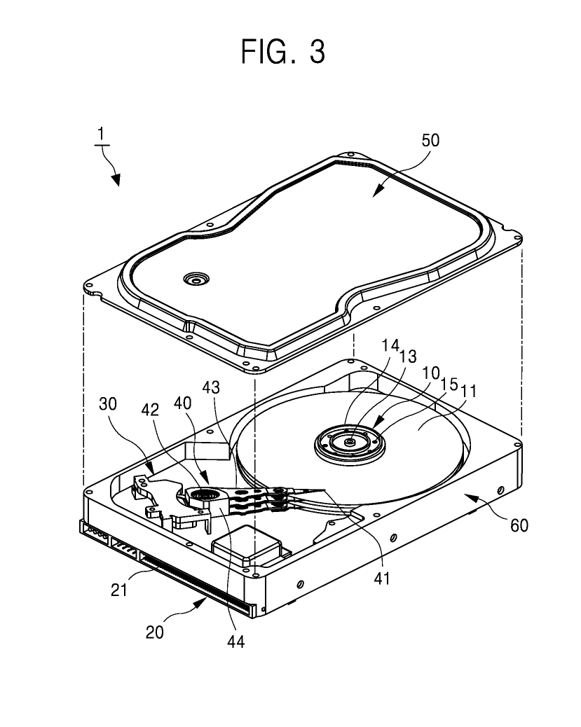

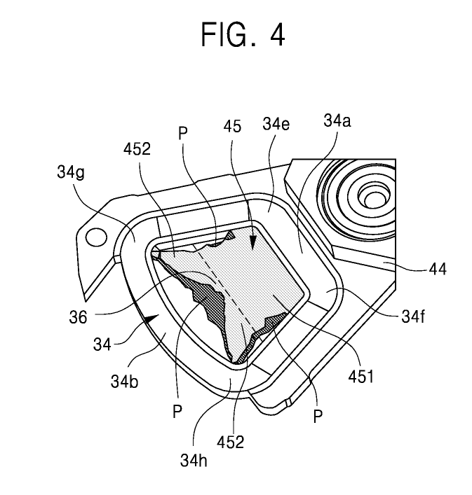

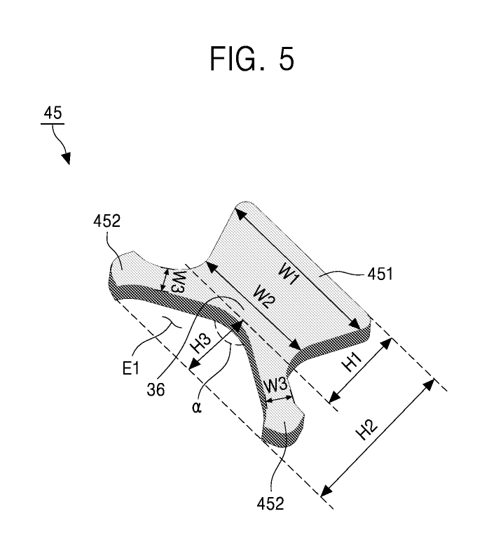

FIG. 2 is an exploded perspective view illustrating major parts of a hard disk drive (HDD) 1 according to an exemplary embodiment of the present general inventive concept. FIG. 3 is a perspective view illustrating that the major parts of the HDD 1 of FIG. 1 are assembled. FIG. 4 is a perspective view illustrating a bobbin of the HDD 1 of FIG. 1 in detail. FIG. 5 is a perspective view illustrating the shape of the bobbin of FIG. 4 that is changed for convenience of manufacturing.

Referring to FIGS. 2-5, the HDD 1 according to the present exemplary embodiment may include a disk pack 10 having at least one disk 11, a printed circuit board assembly (PCBA) 20, a head stack assembly (HSA) 40 having at least one read/write head 41 mounted on one end portion thereof and a bobbin 45, around which a voice coil 34 is wound, provided at the other end portion thereof. A voice coil motor (VCM) 30 is provided to pivot the HSA 40 about a pivot shaft 48, a cover 50, and a base 60. The above-described constituent elements are installed within the base 60 and the cover 50 is coupled to the base 60 to protect the constituent elements installed within the base 60.

The disk pack 10 may include a plurality of disks 11 arranged in a vertical direction, a shaft 13 to form the rotation center of the disks 11, a spindle motor hub (not illustrated) provided radially outside the shaft 13 and supporting the disks 11, a spindle motor (not illustrated) to rotate the spindle motor hub, a clamp 14 coupled to an upper portion of the spindle motor hub, and a clamp screw 15 pressing the clamp 14 to fix the disks 11 to the spindle motor hub.

The PCBA 20 may include a printed circuit board (PCB, not illustrated) having a plate shape and coupled to a lower portion of the base 60, a flexible printed circuit board (FPCB, not illustrated) installed on an upper surface of the base 60 close to the HSA 40 and electrically connecting the HSA 40 and the PCB, and a PCB connector 21 provided at a side of the PCB. A plurality of chips and circuits (not illustrated) to control the disk pack 10, the HSA 40, the VCM 30 and other components disposed within the base 60 may be provided on the PCB to communicate signals to and from one or more external devices via the PCB connector 21.

The HSA 40, as a carriage to record data on at least one disk 11 or read data from at least one disk 11, may include the at least one read/write head 41 to write data to the disk 11 or read the written data, an actuator arm 43 pivoting around a pivot shaft 42 across the disk 11 to allow the read/write head 41 to access data on the disk 11, a pivot shaft holder 44 rotatably supporting the pivot shaft 42 and supporting the actuator arm 43 that is coupled thereto, and the bobbin 45 provided at the opposite side of the actuator arm 43 with respect to the pivot shaft holder 44.

A plurality of read/write heads 41 may read or write information with respect to the disk 11 that are rotating, respectively, by sensing a magnetic field formed on the surface of the disk 11 or magnetizing the surface of the disk 11. The read/write head 41 to read and write data includes a read head to sense the magnetic field of the disk 11 and a write head to magnetize the disk 11.

The VCM 30 can be a form of a driving motor that may rotate the actuator arm 43 of the HSA 40 in a predetermined direction to move the read/write head 41 to a desired position on the one or more disks 11. The VCM 30 may include a VCM yoke 31 having magnets 33 and the voice coil 34 arranged under the VCM yoke 31 and coupled to the bobbin 45.

The VCM 30 utilizes Fleming's left hand rule, that is, when current is applied to a conductive body existing in a magnetic field, an electromagnetic force is generated. As current is applied to the VCM coil 34 located between the magnets 33, a force is generated and applied to the bobbin 45 to rotate the bobbin 45 and the actuator arm 43 positioned on the opposite side of the pivot shaft 48. Accordingly, as the actuator arm 43 is rotated in a predetermined direction, the read/write head 41 mounted at the end portion of the actuator arm 43 moves radially across the disk 11 that is rotating, and simultaneously searches and accesses a desired track (not illustrated). Thus, the data may be recorded on the disk 11 or the recorded data may be read from the disk 11. The VCM yoke 31 to concentrate magnetic flux generated by the magnets 33 in a predetermined direction may be manufactured of pure steel having a high magnetic permeability.

In the HDD 1, during driving of the HSA 40, due to a butterfly mode (BFM) of the HSA 40 including the actuator arm 43, a portion 401 of the actuator arm 43 provided at one side of the pivot shaft holder 44 and another portion 402 of the actuator arm 43 where the bobbin 45 is installed are in the shape of being bent or twisted with each other with respect to the pivot shaft 42. The butterfly mode generates track mis-registration (TMR) which prevents the read/write head 41 from precisely tracking a track on a disk 11. As a result, the performance of the HDD 1 may be deteriorated.

To reduce the TMR, in the present exemplary embodiment, the material and structure of the bobbin 45 may be changed and improved to increase a servo bandwidth so that a butterfly mode frequency may be increased. That is, to increase the butterfly mode frequency, the bobbin 45 may be manufactured of a metal material, such as aluminum and alloys thereof. Also, the shape of the bobbin 45 may be optimized to avoid an increase in the mass and/or the moment of inertia of the bobbin 45 that may be generated as the bobbin 45 manufactured of a metal material is employed, which will described later.

The BFM frequency f of the HSA 40 is proportional to an elastic coefficient k, but inversely proportional to a value of mass m. When the bobbin 45 is made of a metal material, the BFM frequency f of the HSA 40 may be higher than that of the bobbin 45 made of a plastic material. Nonetheless, when the plastic material is simply replaced by the metal material, it is a problem that the overall mass and the moment of inertia of the HSA 40 are increased. Thus, there is a need for optimal design of the shape of the bobbin 45 which may increase the BFM frequency f of the HSA 40 without increasing or much increasing the mass or the mass and moment of inertia of the bobbin 45.

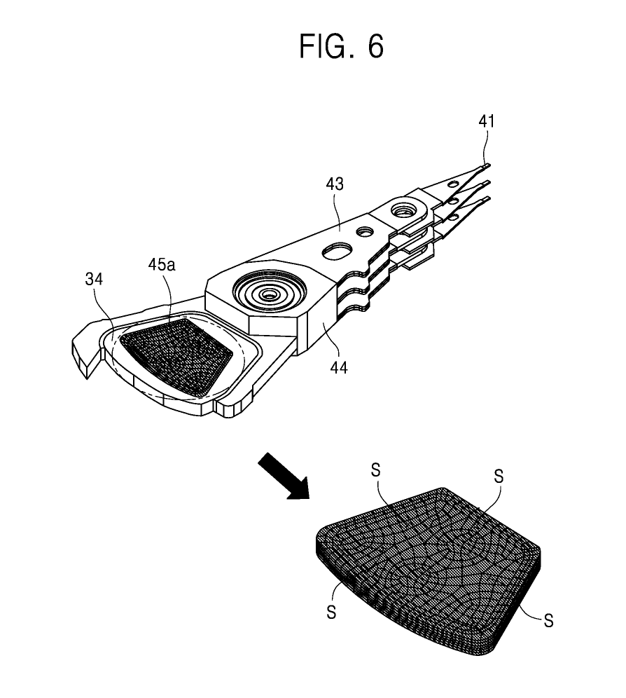

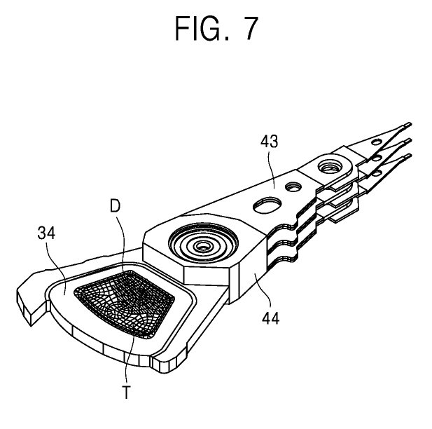

FIG. 6 schematically illustrates a computer modeling process to optimize the phase of the bobbin 45 of FIG. 4. FIGS. 7-10 are perspective views schematically illustrating the phase optimization design process of a bobbin 45a of FIG. 6. Referring to FIG. 6, the bobbin 45a that is an object of modeling for the optimization of the shape of the bobbin 45 may be made of an aluminum material including alloys thereof to have a shape corresponding to the trapezoidal shape of the voice coil 34, and include a plurality of divided unit segments S.

To determine an optimal shape of the bobbin 45, as illustrated in FIGS. 7-10, in a state of not considering the moment of inertia of the bobbin 45, a process to maximize a value of the BFM frequency f of the HSA 40 is repeated with respect to the bobbin 45 made of an aluminum material.

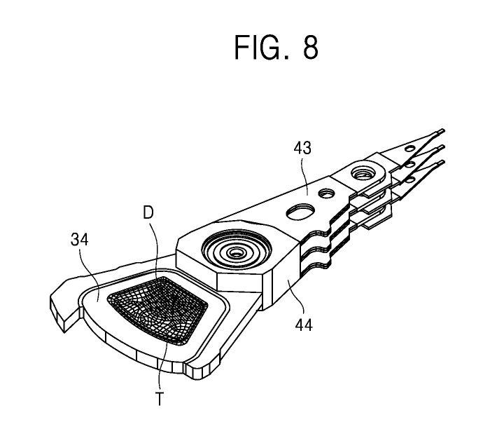

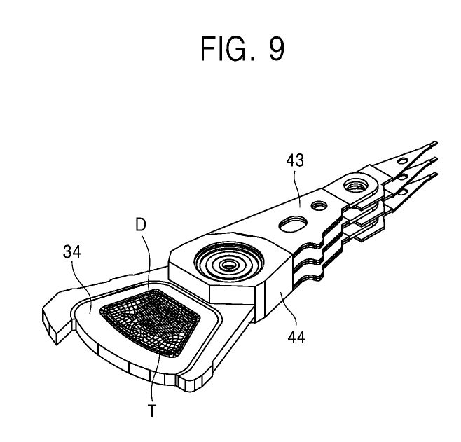

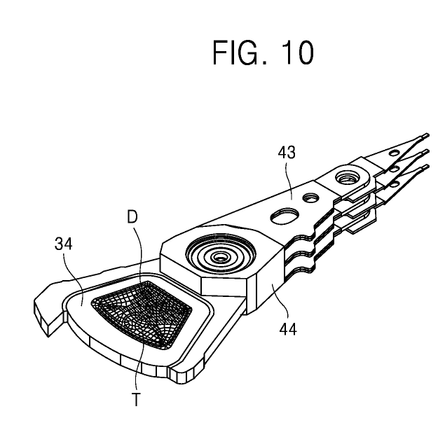

FIG. 7 illustrates the shape of the bobbin 45a when the process to maximize a value of the BFM frequency f of the HSA 40 is performed one (1) time, by forming the unit segments S of the bobbin 45a of an aluminum material. FIG. 8 illustrates the shape of the bobbin 45a when the process is repeated five (5) times. FIG. 9 illustrates the shape of the bobbin 45a when the process is repeated seven (7) times. FIG. 10 illustrates the shape of the bobbin 45a when the process is repeated thirteen (13) times. In FIGS. 7-10, a dark area D denotes an aluminum material region, whereas a blurred area T denotes an empty region having no material.

In the same manner as illustrated in FIGS. 7-10, the shape of the bobbin 45 that is optimized and obtained by increasing the number of repetitions is as illustrated in FIG. 4. Edges of the bobbin 45 are illustrated as being roughened and jagged because FIG. 4 is a magnified version of an actual metal material bobbin of the present general inventive concept. An optimized shape of the bobbin 45, considering manufacturing convenience and costs, is illustrated in FIG. 5.

A plurality of protruding portions P of FIG. 4 may be generated from the shape obtained from a result of phase optimization of the bobbin 45a of FIGS. 7-10 (as illustrated in FIG. 6). The protruding portions P may be changed according to the shape and size of the bobbin 45a. Thus, in the following description, an exemplary embodiment will be described based on the shape of the bobbin 45 considering manufacturing convenience, in which the protruding portions P are omitted, as illustrated in FIG. 5. Since this condition is similar to those of other exemplary embodiments, a repeated description thereof will be omitted.

The bobbin 45 of the present exemplary embodiment has a shape obtained by increasing the BFM frequency f of the HSA 40 without considering moment of inertia. The bobbin 45 is provided to substantially have a plane “ [symbol] ” shape and to be coupled to the voice coil 34.

As illustrated in detail in FIGS. 4 and 5, the bobbin 45 includes a bobbin body 451 coupled to a first end portion 34a of the voice coil 34 adjacent to the pivot shaft holder 44, and a pair of bobbin legs 452 extending from an end portion 36 of the bobbin body 451 toward corner areas 34g and 34h of a second end portion 34b of the voice coil 34 that are separated from each other, and coupled thereto.

That is, the bobbin body 451 may be symbolized by the upper straight portion of the plane [symbol] shape and may be coupled to an inner side of the first end portion 34a and both corner portions 34e and 34f of the first end portion 34a of the voice coil 34 adjacent to the pivot shaft holder 44. The pair of bobbin legs 452 may be symbolized by the lower arc-shaped portions of the plane [symbol] shape and may respectively extend to both corner portions 34g and 34h of the second end portion 34b of the voice coil 34 from the end portion 36 of the bobbin body 451 and may be coupled to both corner portions 34g and 34h of the second end portion 34b of the voice coil 34. The plane [symbol] shape is not limited to a particular orientation, but may be rotated in any position commensurate with the rotation of the bobbin 45 about the pivot shaft 44.

The bobbin body 451 may be coupled to the first end portion 34a of the voice coil 34 adjacent to the pivot shaft holder 44 to improve a stiffness effect on the overall HSA 40 in the BFM of the HSA 40. In the bobbin body 451, the width W1 of a portion adjacent to the pivot shaft holder 44 may be larger than the width W2 towards the center of the bobbin portion thereof.

The pair of bobbin legs 452, each having a width W3, may respectively extend from the end portion 36 of the bobbin body 451 towards both corner portions 34g and 34h of the second end portion 34b of the voice coil 34 and may be coupled to both corner portions 34g and 34h of the second end portion 34b of the voice coil 34, to reduce a mass effect on the overall HSA 40 in the BFM of the HSA 40.

As illustrated in FIG. 4, the voice coil 34 of the present exemplary embodiment may have a trapezoidal shape in which the width of the first end portion 34a adjacent to the pivot shaft holder 44 is narrower than that of the opposite portion 34b. Also, the bobbin body 451 may be coupled to the inner side of the first end portion 34a and both corner portions 34e and 34f of the first end portion 34a of the voice coil 34 adjacent to the pivot shaft holder 44 and extends toward the bobbin legs 452. The pair of bobbin legs 452 may respectively extend from the end portion 36 of the bobbin body 451 to both corner portions 34g and 34h of the second end portion 34b of the voice coil 34, forming an angle “α”, which may be an obtuse angle, so that the bobbin 45 according to the present exemplary embodiment may have a plane [symbol] shape as described above.

Also, as illustrated in FIG. 5, the height H1 of the bobbin body 451 may be provided to be about ⅘ to ⅚ of the overall height H2 of the bobbin 45 from the first end portion 34a to the second end portion 34b. Accordingly, the height H3 of a center portion of a removal area E1 between the bobbin legs 452 is provided to be about ⅕ to ⅙ of the overall height H2 of the bobbin 45.

Using a metal material including aluminum or an aluminum alloy in the bobbin 45 according to the present exemplary embodiment, the BFM frequency f of the HSA 40 may be increased by about 190 Hz compared to a plastic bobbin known to the prior art. Accordingly, with an increased BFM frequency, the TMR may be reduced, and reliability of the HDD 1 according to the present exemplary embodiment may be improved.

An HDD according to another exemplary embodiment of the present general inventive concept will be described below with reference to the accompanying drawings. However, for convenience of explanation, the descriptions on the elements the same as those in the above-described exemplary embodiment may be omitted herein.

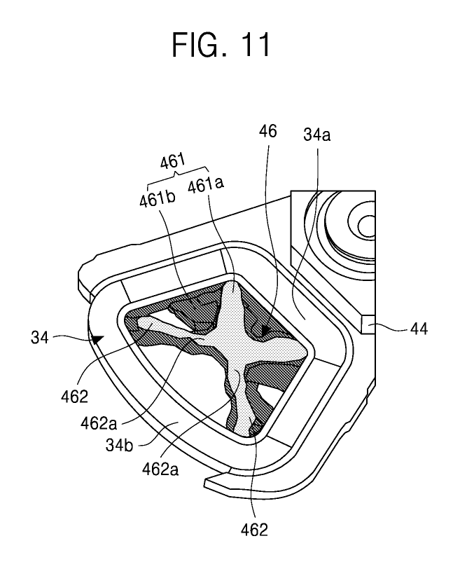

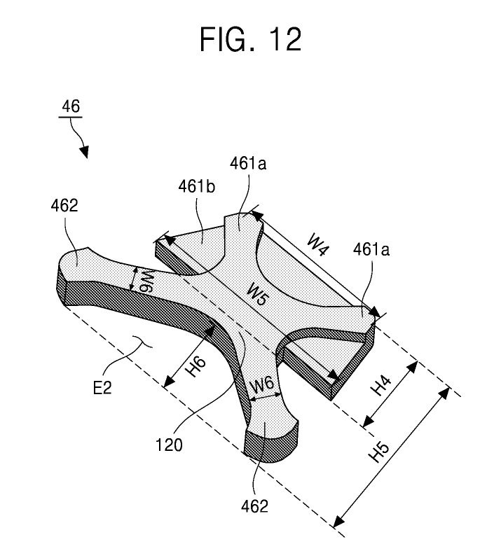

FIG. 11 is a perspective view of a bobbin 46 of an HDD according to another exemplary embodiment of the present general inventive concept. FIG. 12 is a perspective view illustrating the shape of the bobbin of FIG. 11 that is changed for convenience of manufacturing. Referring to FIGS. 11 and 12, the bobbin 46 according to the present exemplary embodiment may include a bobbin body 461 coupled to the first end portion 34a of the voice coil 34 adjacent to the pivot shaft holder 44, and a pair of bobbin legs 462 extending from an end portion 110 of the bobbin body 461 toward areas of the second end portion 34b of the voice coil 34 that are separated from each other, and coupled to the bobbin body 461.

The bobbin body 461 may be coupled to the first end portion 34a of the voice coil 34 adjacent to the pivot shaft holder 44 to improve the stiffness effect on the overall HSA 40 in the BFM of the HSA 40. The bobbin body 461 may include a pair of first body units 461a and a second body unit 461b having an upper surface at a position lower than the upper surface of the first body units 461a. Since the lower surfaces of the first body units 461a and the second body unit 461b may exist on the same plane, the thicknesses of the first body units 461a and the second body unit 461b may be different from each other.

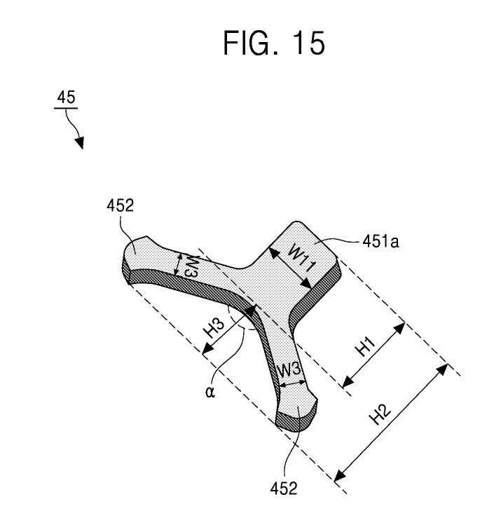

A purpose for the different thicknesses between the first body units 461a and the second body unit 461b may be to minimize the reduction of the BFM and reduce the mass and moment of inertia as one of plans to reduce the weight of the HSA 40. That is, the pair of first body units 461a may be respectively extended from the end portions 462a of the pair of bobbin legs 462 to substantially form an “X” shape with the pair of bobbin legs 462. The second body unit 461b may have a thinner thickness than each of the first body units 461a. Also, a width W4 of a portion adjacent to the pivot shaft holder 44 may be smaller than a width W5 of the opposite portion thereof towards the end portion 120 of the bobbin body 461. Also, as illustrated below with regard to FIG. 15, the first body units 461a may alternatively be formed into a single first body unit 451a to allow the combination of the two bobbin legs 462 and single first body unit 451a a “Y” shape positioned above the second body unit 461b.

The pair of bobbin legs 462, each having a width W6, respectively extend from the end portion 120 of the bobbin body 461 to areas of the second end portion 34b of the voice coil 34 that are separated from each other, to reduce a mass effect on the overall HSA 40 in the BFM of the HSA 40. Accordingly, the bobbin 46 according to the present exemplary embodiment may have a plane [symbol] shape as a whole when combining the first and second body units 461a and 461b to from the straight portion of the plane [symbol] shape with two arc-shaped leg portions 462.

Also, the height H4 of each of the bobbin bodies 461a and 461b may be provided to be about ⅘ to ⅚ of the overall height H5 of the bobbin 46. Accordingly, the height H6 of a center portion of a removal area E2 between the bobbin legs 462 is provided to be about ⅕ to ⅙ of the overall height H5 of the bobbin 46 (as illustrated in FIG. 12).

In the bobbin 46 formed of a metal material including aluminum or aluminum alloy described herein and according to the present exemplary embodiment, the BFM frequency f of the HSA 40 may be increased by about 160 Hz compared to plastic bobbins. Also, the moment of inertia may be reduced to about 0.49 kgmm², compared to 0.51 kgmm² of the plastic bobbins. Accordingly, the TMR may be reduced, and reliability of the HDD 1 according to the present exemplary embodiment may be improved. A reduced moment of inertia may allow the bobbin 46 to better overcome forces such as starting friction and other forces that may impede the movement of the HSA 40.

An HDD according to another exemplary embodiment of the present general inventive concept will be described below with reference to the accompanying drawings. However, for convenience of explanation, the descriptions on the elements same as those in the above first-described exemplary embodiment may be omitted herein.

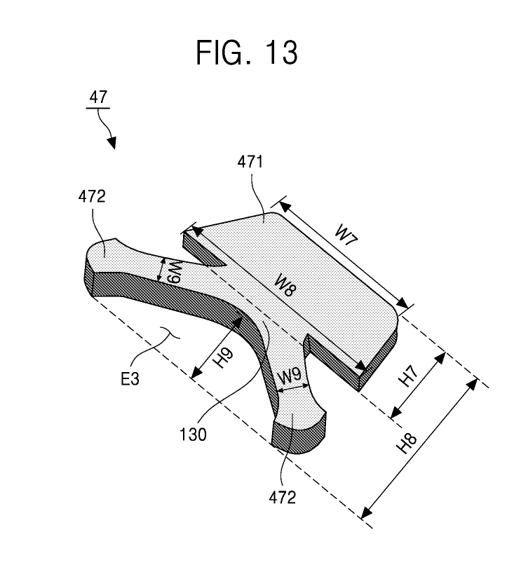

FIG. 13 is a perspective view of a bobbin 47 of an HDD according to another exemplary embodiment of the present general inventive concept. Referring to FIG. 13, the bobbin 47 according to the present exemplary embodiment includes a bobbin body 471 coupled to an end portion of a voice coil (not illustrated) adjacent to a pivot shaft holder (not illustrated), and a pair of bobbin legs 472 extending from an end portion 130 of the bobbin body 471 toward areas of the other end portion of the voice coil that are separated from each other, and coupled thereto.

The bobbin body 471 may be provided such that a width W7 of a portion adjacent to the pivot shaft holder (not illustrated) may be smaller than a width W8 of a portion that is not adjacent to the pivot shaft holder (not illustrated), as in the above second-described exemplary embodiment. The pair of bobbin legs 472, each having a width W9, respectively extend from the end portion 130 of the bobbin body 471 to areas of the second end portion of the voice coil (not illustrated) that are separated from each other, and coupled thereto. Accordingly, the bobbin 47 according to the present exemplary embodiment has a plane [symbol] shape as a whole, as described above.

Also, the height H7 of the bobbin body 471 is provided to be about ⅘ to ⅚ of the overall height H8 of the bobbin 47. Accordingly, the height H9 of a center portion of a removal area E3 between the pair of bobbin legs 472 is provided to be about ⅕ to ⅙ of the overall height H8 of the bobbin 47 (as illustrated in FIG. 13).

In the metal including aluminum and aluminum alloys materials bobbin 47 according to the present exemplary embodiment, the BFM frequency f of the HSA 40 may be increased and the moment of inertia may be reduced, compared to the plastic bobbins. Accordingly, TMR may be reduced and reliability of the HDD 1 according to the present exemplary embodiment may be improved.

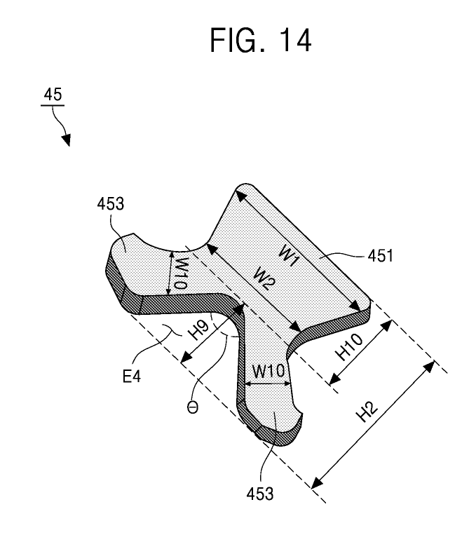

FIGS. 14 and 15 are perspective views illustrating alternate shapes of a bobbin according to exemplary embodiments of the present general inventive concept.

As illustrated in FIG. 14, a height H10 of the bobbin body 451 may be provided to be about ½ to ¾ of the overall height H2 of the bobbin 45 from the first end portion of the voice coil to the second end portion of the voice coil (not illustrated). Accordingly, the height H9 of a center portion of a removal area E4 between the bobbin legs 453 may be provided to be about ½ to ¼ of the overall height H2 of the bobbin 45. Also, the bobbin legs 453 in this exemplary embodiment may have a wider width which may allow the angle “θ” between the bobbin legs 453 to be a right angle or an acute angle, as illustrated in FIG. 14 and having a similar [symbol] shape as described previously.

As illustrated in FIG. 15, the bobbin body 451a may alternatively be formed of a single portion having a width W11 smaller than widths W1 and W2, but larger than the width W3 of the bobbin legs. The narrower width bobbin body 451a may allow the bobbin 45 to form a “Y” shape that includes the bobbin body 451a and the bobbin legs 452. This configuration of the bobbin 45 may allow the bobbin to have a reduced mass and moment of inertia than prior art bobbins and may allow the frequency of the resonant mode such as a butterfly mode of a HSA to be increased, TSM to be reduced, and overall reliability improved.

Although, in the above-described exemplary embodiments, the bobbin is manufactured of an aluminum material, the bobbin may be manufactured of other metal material and metal alloys.

As described above, in the hard disk drive according to the present general inventive concept, a servo bandwidth is increased by increasing the butterfly mode (BFM) frequency of the HSA, so that track mis-registration (TMR) may be reduced.

While the present general inventive concept has been particularly illustrated and described with reference to exemplary embodiments thereof, it will be understood that various changes in form and details may be made therein without departing from the spirit and scope of the following claims.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A hard disk drive comprising:
an actuator arm to pivot over a disk around a pivot shaft as a center of rotation to allow a read/write head disposed on one side of the pivot shaft to access data on the disk;
a bobbin provided at an opposite side of the read/write head with respect to a pivot shaft holder that rotatably supports the pivot shaft; and
a voice coil coupled to the bobbin,
wherein the bobbin comprises:
a bobbin body coupled to a first end portion of the voice coil adjacent to the pivot shaft holder; and
a plurality of bobbin legs extending from an end portion of the bobbin body toward areas of a second end portion of the voice coil on an opposite side of the first end portion of the voice coil, and coupled to the areas of the second end portion of the voice coil.

2. The hard disk drive of claim 1, wherein the plurality of bobbin legs are a pair of bobbin legs, and the bobbin substantially has a plane [symbol] shape.

3. The hard disk drive of claim 2, wherein the voice coil substantially has a trapezoidal shape, and the pair of bobbin legs are extended from the end portion of the bobbin body toward both corners of the second end portion of the voice coil, forming an obtuse angle, and coupled to both corners of the second end portion of the voice coil.

4. The hard disk drive of claim 2, wherein the bobbin body has a height to correspond to ⅘ to ⅚ of the overall height of the bobbin.

5. The hard disk drive of claim 2, wherein the bobbin body comprises:
a pair of first body units, each having an upper surface provided on the substantially same plane with an upper surface of each of the pair of bobbin legs; and
a second body unit having an upper surface at a position lower than an upper surface of each of the pair of first body units.

6. The hard disk drive of claim 5, wherein the pair of first body units respectively extend from a base portion of each of the pair of bobbin legs, to substantially form an “X” shape with the pair of bobbin legs, and the second body unit substantially has a trapezoidal shape.

7. The hard disk drive of claim 6, wherein the thicknesses of the first body units and the second body unit are different from each other, and a width of a portion of the second body unit adjacent to the pivot shaft holder is smaller than a width of an opposite portion of the second body unit.

8. The hard disk drive of claim 1, wherein a width of a portion of the bobbin body adjacent to the pivot shaft holder is larger than a width of an opposite portion of the bobbin body, and the plurality of bobbin legs are a pair of bobbin legs extending from both corner portions of the end portion of the bobbin body and respectively coupled to the areas of the second end portion of the voice coil that are separated from each other.

9. The hard disk drive of claim 1, wherein a width of a portion of the bobbin body adjacent to the pivot shaft holder is smaller than a width of an opposite portion of the bobbin body, and the plurality of bobbin legs are a pair of bobbin legs extending from a center portion of the end portion of the bobbin body and respectively coupled to the areas of the second end portion of the voice coil that are separated from each other.

10. The hard disk drive of claim 1, wherein the bobbin is formed of a metal material.

11. The hard disk drive of claim 10, wherein the bobbin is formed of aluminum or an aluminum alloy.

12. A hard disk drive, comprising:
at least one hard disk;
a head stack assembly to vibrate at a resonance frequency during an operation thereof, the head stack assembly having a pivot shaft and further comprising;
an actuator arm having a read/write head positioned on one side of the pivot shaft; and
a voice coil wound around a bobbin on another side of the pivot shaft, the bobbin having a shape configured to increase the resonance frequency of the head stack assembly.

13. The hard disk drive of claim 12, wherein the bobbin further comprises:
a body portion adjacent to a first end of the voice coil; and
a plurality of leg portions extending from the body portion to a second end of the voice coil.

14. The hard disk drive of claim 13, wherein the body portion comprises:
a plurality of first body units connected to the plurality of leg portions on a first level of the bobbin; and
a second body unit disposed below and in contact with the plurality of first body units, the second body unit having a trapezoidal shape.

15. The hard disk drive of claim 13, wherein the plurality of leg portions have substantially the same width.

16. The hard disk drive of claim 13, wherein the body portion has a first width and the plurality of leg portions are separated from each other by a second width larger than the first width.

17. A hard disk drive, comprising:
an actuator arm including a read/write head disposed at one end thereof, a voice coil disposed at an opposite end thereof and a pivot shaft holder disposed between the read/write head and the voice coil; and
a bobbin disposed within the voice coil, the bobbin including a body portion and two leg portions extending from the body portion and at a predetermined angle away from each other.

18. The hard disk drive of claim 17, wherein the two leg portions extend from the body portion to form an acute angle with each other.

19. The hard disk drive of claim 17, wherein the body portion and the two leg portions substantially form a “Y” shape.
